(19) United States
(12) Patent Application Publication
(10) Pub. No.: US 2023/0091891 A1
(43) Pub. Date: Mar. 23, 2023

(54) METHOD AND APPARATUS OF OFDM SYMBOL ADJUSTMENT FOR A CONFIGURED SIDELINK TRANSMISSION

(71) Applicant: Samsung Electronics Co., Ltd., Suwon-si (KR)

(72) Inventors: Hongbo Si, Plano, TX (US); Emad N. Farag, Flanders, NJ (US); Carmela Cozzo, San Diego, CA (US)

(21) Appl. No.: 17/930,402

(22) Filed: Sep. 7, 2022

Related U.S. Application Data
(60) Provisional application No. 63/247,640, filed on Sep. 23, 2021.

(51) Int. Cl. H04L 27/26; H04L 5/00

(52) U.S. Cl. CPC H04L 27/2646; H04L 27/2607; H04L 5/0007

(57) ABSTRACT

Methods and apparatuses for orthogonal frequency-division multiplexing (OFDM) symbols adjustment for a configured sidelink (SL) transmission in a wireless communication system. A method of user equipment (UE) method includes receiving a set of configurations, determining a set of time and frequency domain resources for at least one SL transmission based on the set of configurations, and determining a duration for a cyclic prefix (CP) extension based on the set of configurations. The method further includes extending a first OFDM symbol of the at least one SL transmission for an interval preceding the first OFDM symbol with the duration for the CP extension and transmitting the at least one SL transmission.

### CROSS-REFERENCE TO RELATED APPLICATIONS AND CLAIM OF PRIORITY

The present application claims priority to U.S. Provisional Patent Application No. 63/247,640, filed on Sep. 23, 2021. The content of the above-identified patent document is incorporated herein by reference.

### TECHNICAL FIELD

The present disclosure relates generally to wireless communication systems and, more specifically, the present disclosure relates to orthogonal frequency-division multiplexing (OFDM) symbol adjustment for a configured sidelink (SL) transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to OFDM symbols adjustment for a configured SL transmission in a wireless communication system.

In one embodiment, a user equipment (UE) in a wireless communication system is provided. The UE includes a transceiver configured to receive a set of configurations and a processor operably coupled to the transceiver. The processor is configured to determine a set of time and frequency domain resources for at least one SL transmission based on the set of configurations; determine a duration for a cyclic prefix (CP) extension based on the set of configurations; and extend a first OFDM symbol of the at least one SL transmission for an interval preceding the first OFDM symbol with the duration for the CP extension. The transceiver is further configured to transmit the at least one SL transmission.

In another embodiment, a method of UE in a wireless communication system is provided. The method includes receiving a set of configurations, determining a set of time and frequency domain resources for at least one SL transmission based on the set of configurations, and determining a duration for a CP extension based on the set of configurations. The method further includes extending a first OFDM symbol of the at least one SL transmission for an interval preceding the first OFDM symbol with the duration for the CP extension and transmitting the at least one SL transmission.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate an example of wireless transmit and receive paths according to various embodiments of the present disclosure;

FIG. 6 illustrates an example of resource pool in Rel-16 NR V2X according to various embodiments of the present disclosure;

FIG. 7 illustrates an example of slot structure for SL transmission and reception according to various embodiments of the present disclosure;

FIG. 8 illustrates an example of CP extension for PUSCH transmission using configured grant according to various embodiments of the present disclosure;

FIG. 9 illustrates an example of forward symbol extension according to various embodiments of the present disclosure;

FIG. 10 illustrates an example of forward symbol extension for configured SL transmission according to various embodiments of the present disclosure;

FIG. 11 illustrates another example of forward symbol extension for configured SL transmission according to various embodiments of the present disclosure;

FIG. 12 illustrates an example of backward symbol extension according to various embodiments of the present disclosure;

FIG. 13 illustrates an example of backward symbol extension for configured SL transmission according to various embodiments of the present disclosure;

FIG. 14 illustrates an example of symbol truncation according to various embodiments of the present disclosure;

FIG. 15 illustrates an example of symbol truncation for configured SL transmission according to various embodiments of the present disclosure;

FIG. 16 illustrates an example of symbol truncation for configured SL transmission according to various embodiments of the present disclosure; and

FIG. 17 illustrates an example method for ODFM symbol adjustment for SL transmissions according to embodiments of the present disclosure.

### DETAILED DESCRIPTION

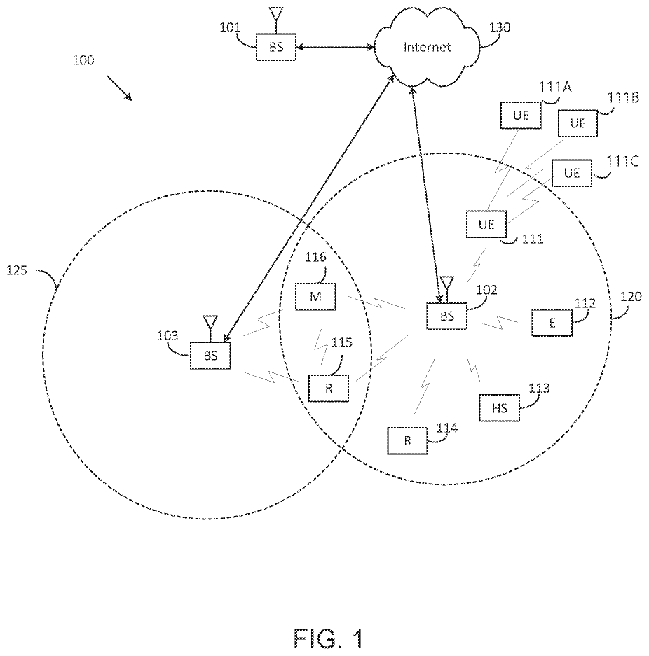

FIG. 1 through FIG. 16, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v.16.6.0, “Physical channels and modulation”; 3GPP TS 38.212 v.16.6.0, “Multiplexing and channel coding”; 3GPP TS 38.213 v16.6.0, “NR; Physical Layer Procedures for Control”; 3GPP TS 38.214: v.16.6.0, “Physical layer procedures for data”; and 3GPP TS 38.331 v.16.5.0, “Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In various embodiments, a UE 116 may communicate with another UE 115 via a SL. For example, both UEs 115-116 can be within network coverage (of the same or different base stations). In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for OFDM symbols adjustment for a configured SL transmission in a wireless communication system. In certain embodiments, and one or more of the gNBs 101-103 includes circuitry, programing, or a combination thereof, for OFDM symbols adjustment for a configured SL transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs (e.g., via a Uu interface or air interface, which is an interface between a UE and 5G radio access network (RAN)) and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UEs 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

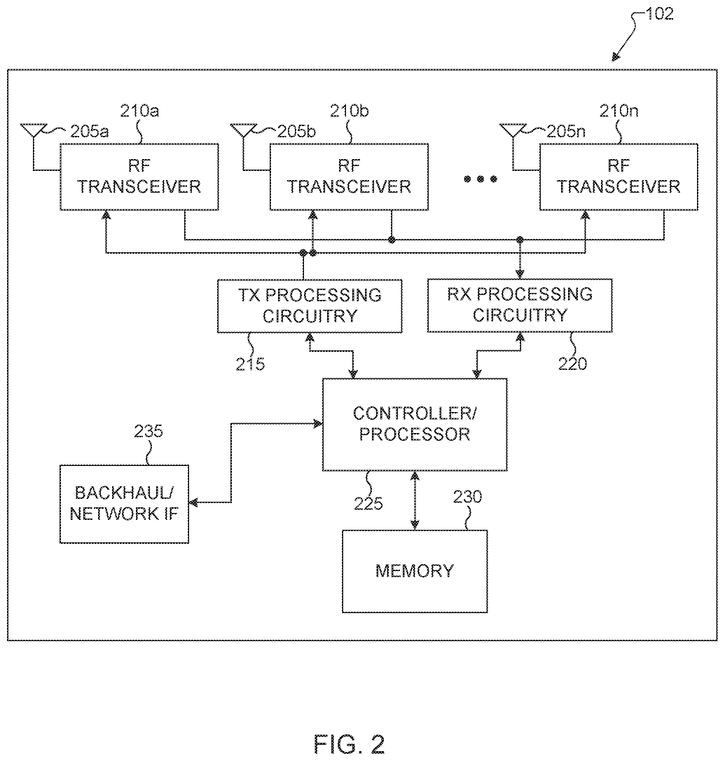

FIG. 2 illustrates an example of gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support OFDM symbols adjustment for a configured SL transmission in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

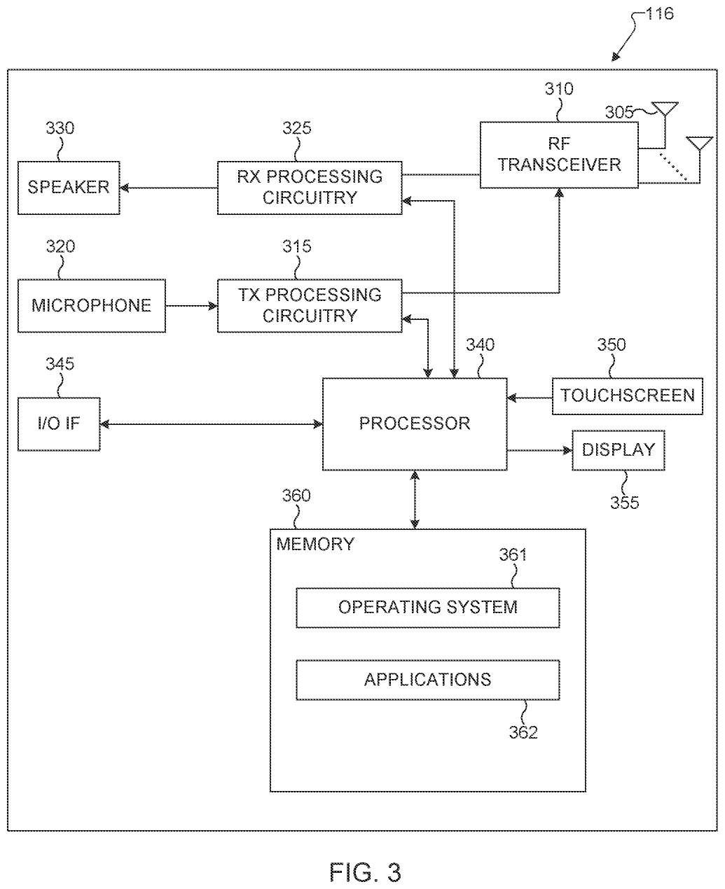

FIG. 3 illustrates an example of UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100 or by other UEs (e.g., one or more of UEs 111-115) on a SL channel. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of downlink and/or SL channel signals and the transmission of uplink and/or SL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for OFDM symbols adjustment for a configured SL transmission in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points and an SL that refers to transmissions from one or more UEs to one or more UEs.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

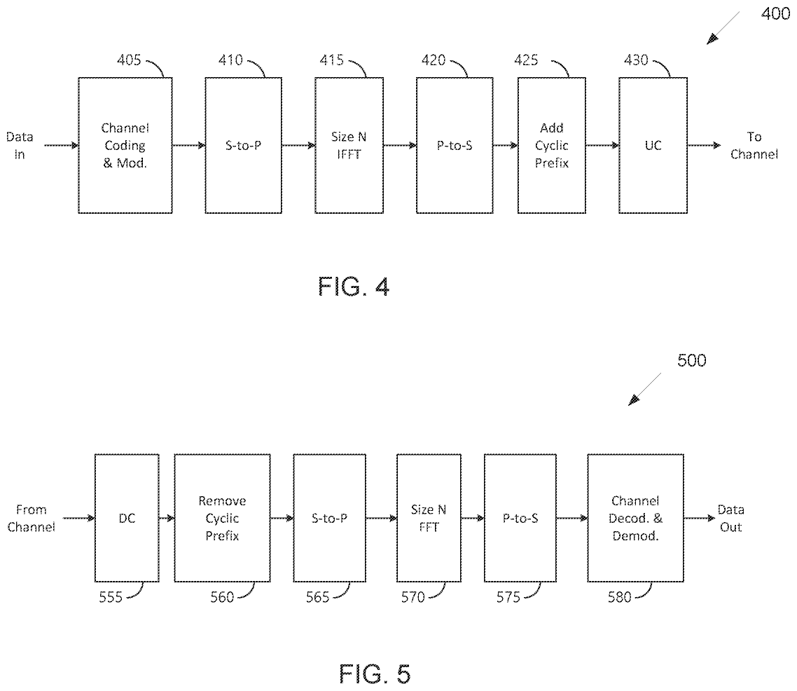

FIG. 4 and FIG. 5 illustrate examples of wireless transmit and receive paths according to this present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL measurements in V2X communication as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the SL to another UE and may implement the receive path 500 for receiving in the downlink from the gNBs 101-103 and/or receiving in the SL from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

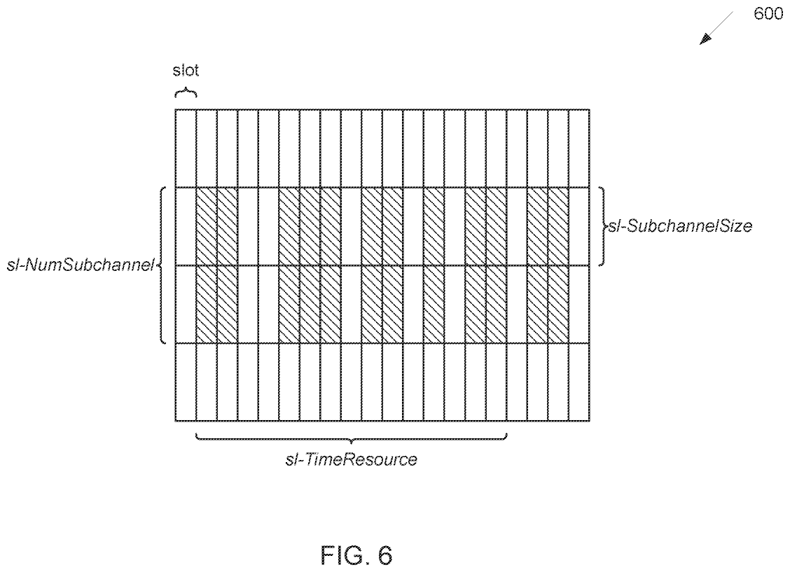

In Rel-16 NR V2X, transmission and reception of SL signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of resource pool in Rel-16 NR V2X 600 according to various embodiments of the present disclosure. An embodiment of the resource pool in Rel-16 NR V2X 600 shown in FIG. 6 is for illustration only.

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for SL, e.g., startSLsymbol+1, and the first symbol configured for SL is duplicated from the second configured for SL, for AGC purpose. The UE may not transmit PSCCH in symbols not configured for SL, or in symbols configured for PSFCH, or in the last symbol configured for SL, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimResourcePSCCH) starting from the second symbol configured for SL, e.g., startSLsymbol+1; and further provided a number of RBs in the resource pool (e.g., sl-FreqResourcePSCCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In frequency domain, PSFCH is transmitted in a single RB, wherein OCC can be possibly applied within the RB for multiplexing, and the location of the RB is determined based on an indication of a bitmap (e.g., sl-PSFCH-RB-Set), and the selection of PSFCH resource is according to the source ID and destination ID.

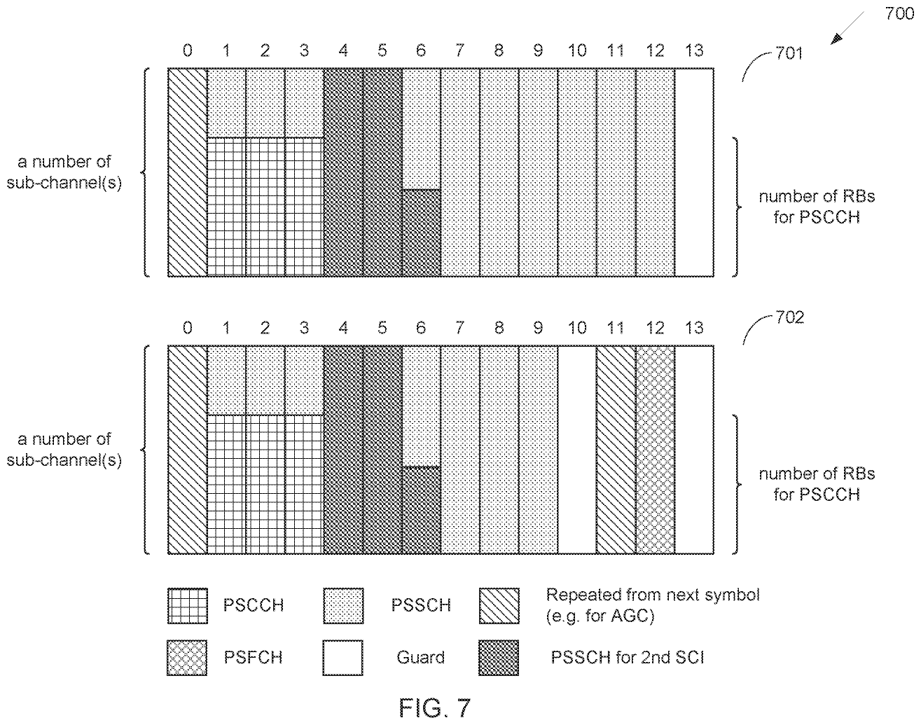

FIG. 7 illustrates an example of slot structure for SL transmission and reception 700 according to various embodiments of the present disclosure. An embodiment of the slot structure for SL transmission and reception 700 shown in FIG. 7 is for illustration only.

The first symbol including PSSCH and PSCCH is duplicated for AGC purpose. An illustration of the slot structure including PSSCH and PSCCH is shown in 701 of FIG. 7, and the slot structure including PSSCH, PSCCH and PSFCH is shown in 702 of FIG. 7.

In Rel-16 NR-U, cyclic prefix (CP) extension was supported for uplink transmissions. The time-continuous signal sₑₓₜ^{(p,μ)}(t) for the interval t_{start,l}^{μ}−Tₑₓₜ≤t<t_{start,l}^{μ} preceding the first OFDM symbol is given by sₑₓₜ^{(p,μ)}(t)=s̅ₗ^{(p,μ)}(t).

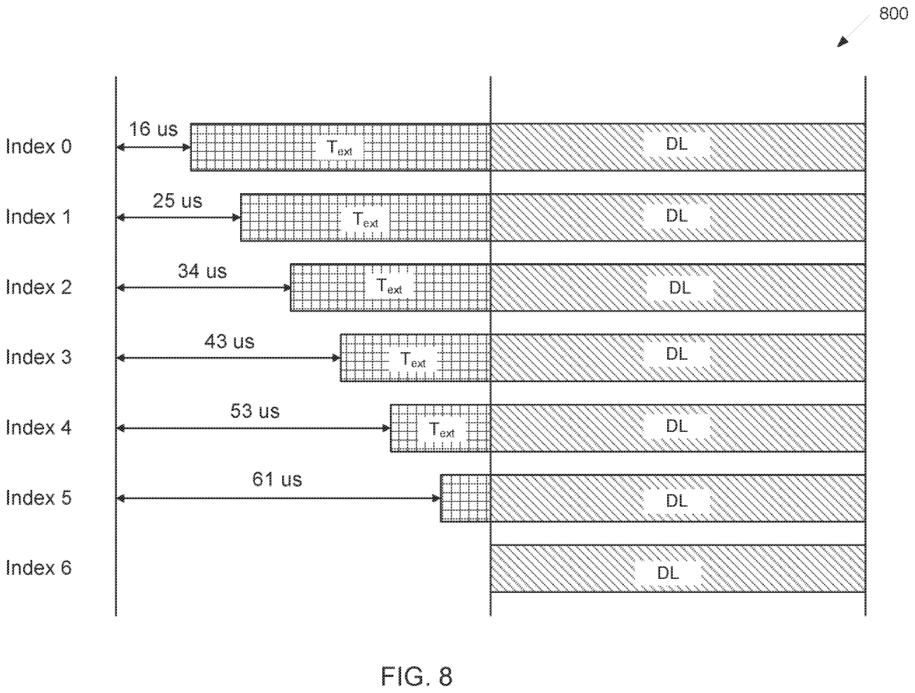

For a PUSCH transmission using configured grant, CP extension of the first uplink symbol was supported in order to construct intended gap duration for randomization of the transmission. The duration of the CP extension Tₑₓₜ is given by Tₑₓₜ=Σₖ₌₁²^{^{μ}}T_{symb,(l-k)mod 7·2}_{^{μ}}μ−Δᵢ and Δᵢ is given by TABLE 1 with the index selected by the UE or provided from higher layer parameter. An illustration of the supported CP extension cases is shown in FIG. 8.

FIG. 8 illustrates an example of CP extension for PUSCH transmission using configured grant 800 according to various embodiments of the present disclosure. An embodiment of the CP extension for PUSCH transmission using configured grant 800 shown in FIG. 8 is for illustration only.

TABLE 1
CP extension parameters for PUSCH transmission
with configured grant.

| index i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σₖ₌₁²_{^{μ}} T_{symb, (l-k)mod 7·2}^{μ} |

For SL operating on unlicensed spectrum, there is a need to adjust the duration of an OFDM symbol on SL, such that the gap between two transmissions can be controlled and randomness of the starting locations for transmission can be supported. In one example, the adjustment of a SL OFDM symbol can be a forward extension, e.g., CP extension, in order to shrink the gap from the previous transmission. In another example, the adjustment of a SL OFDM symbol can be a backward extension, in order to shrink the gap for the following transmission. In yet another example, the adjustment of a SL OFDM symbol can be a truncation from the starting of the symbol (e.g., AGC symbol). This disclosure focuses on the details of the SL OFDM duration adjustment for configured SL transmission and the indication of the adjustment.

In one embodiment, the examples of SL symbol adjustment covered in this disclosure can be applicable to at least one configured SL transmission. For one example, the configured SL transmission can be a PSSCH transmission configured by higher layer parameter. For another example, the configured SL transmission can be a PSFCH transmission. For yet another example, the configured SL transmission can be S-SS/PSBCH block transmission.

Various embodiments of the present disclosure focus on symbol duration adjustment for SL transmissions, including at least configured sidelink transmissions such as PSSCH, PSFCH, and S-SS/PSBCH block. More precisely, the present disclosure includes at least following components: (1) forward symbol extension for sidelink transmission; (2) backward symbol extension for sidelink transmission; (3) symbol truncation for sidelink transmission; (4) sidelink symbol adjustment indication, for example, (i) fixed symbol adjustment in specification and (ii) symbol adjustment indication by RRC parameter; and (5) sidelink and uplink symbol alignment.

In one embodiment, an OFDM symbol for sidelink transmission can be forward extended for a duration of Tₑₓₜ. This can also be referred as CP extension.

In one example, the time-continuous signal sₑₓₜ^{(p,μ)}(t) for the interval t_{start,l}^{μ}−Tₑₓₜ≤t<t_{start,l}^{μ} preceding the sidelink OFDM symbol can be given by sₑₓₜ^{(p,μ)}(t)=s̅ₗ^{(p,μ)}(t), or sₑₓₜ^{(p,μ)}(t)=s̅ₗ^{(p,μ)}(t+T_{symb,l}^{μ}−N_{CP,l}^{μ}·T_{c}).

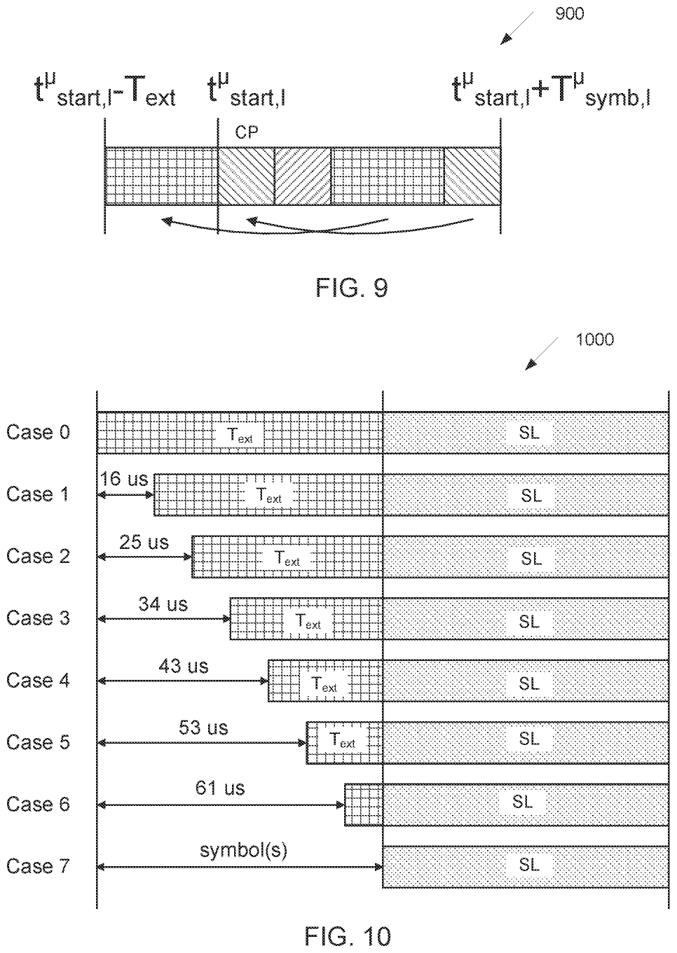

FIG. 9 illustrates an example of forward symbol extension 900 according to various embodiments of the present disclosure. An embodiment of the forward symbol extension 900 shown in FIG. 9 is for illustration only.

An illustration of this example for forward symbol extension is shown in FIG. 9, wherein the portions with the same pattern are repeated.

In one example, for a configured sidelink transmission (e.g., configured PSSCH and/or PSFCH and/or S-SS/PSBCH block), the duration of the forward extension of a sidelink symbol (e.g., the first symbol of the sidelink transmission) can be given by Tₑₓₜ=Σₖ₌₁^{F}^{ᵢ}T_{symb,(l-k)mod 7·2}_{^{μ}}μ−Δᵢ.

In another example, for a configured sidelink transmission (e.g., configured PSSCH and/or PSFCH and/or S-SS/PSBCH block), the duration of the forward extension of a sidelink symbol (e.g., the first symbol of the sidelink transmission) can be given by Tₑₓₜ=max(Σₖ₌₁^{F}^{ᵢ}T_{symb,(l-k)mod 7·2}_{^{μ}}μ−Δᵢ,0).

In yet another example, for a configured sidelink transmission (e.g., configured PSSCH and/or PSFCH and/or S-SS/PSBCH block), the duration of the forward extension of a sidelink symbol (e.g., the first symbol of the sidelink transmission) can be given by Tₑₓₜ=min(max(Σₖ₌₁^{F}^{ᵢ}T_{symb,(l-k)mod 7·2}_{^{μ}}μ−Δᵢ,0), Σₖ₌₁²^{^{μ}}T_{symb,(l-k)mod 7·2}_{^{μ}}μ).

In yet another example, for a configured sidelink transmission (e.g., configured PSSCH and/or PSFCH and/or S-SS/PSBCH block), the duration of the forward extension of a sidelink symbol (e.g., the first symbol of the sidelink transmission) can be given by Tₑₓₜ=min (max (Σₖ₌₁^{F}^{ᵢ}T_{symb,(l-k)mod 7·2}_{^{μ}}μ−Δᵢ,0), Σₖ₌₁²^{^{μ}}T_{symb,(l-k)mod 7·2}_{^{μ}}μ).

In one example, the duration of the forward extension of a sidelink symbol can be supported for at least one of the following cases.

FIG. 10 illustrates an example of forward symbol extension for configured sidelink transmission 1000 according to various embodiments of the present disclosure. An embodiment of the forward symbol extension for configured sidelink transmission 1000 shown in FIG. 10 is for illustration only.

In a first case (e.g., case 0 in FIG. 10), the intended gap duration after applying the forward symbol extension for the configured sidelink transmission is 0, and the corresponding value of Δᵢ (i=0) is given by TABLE 2. In one consideration, F₀ can be fixed as 2^{μ} in this case. In another consideration, F₀ can be provided by higher layer parameter. In yet another consideration, F₀ can be fixed as 1 in this case.

In one variant of this case, the forward symbol extension can be symbol repetition(s). For instance, the first symbol of the scheduled sidelink transmission is repeated F₀ times and transmitted proceeding the configured sidelink transmission.

In another case (e.g., case 1 in FIG. 10), the intended gap duration after applying the forward symbol extension for the configured sidelink transmission is 16 us, and the corresponding value ofΔᵢ (i=1) is given by TABLE 2. In one consideration, F₁ can be fixed as 2^{μ} in this case. In another consideration, F₁ can be provided by higher layer parameter. In yet another consideration, F₁ can be fixed as 1 in this case.

In another case (e.g., case 2 in FIG. 10), the intended gap duration after applying the forward symbol extension for the configured sidelink transmission is 25 us, and the corresponding value of Δᵢ (i=2) is given by TABLE 2. In one consideration, F₂ can be fixed as 2^{μ} in this case. In another consideration, F₂ can be provided by higher layer parameter. In yet another consideration, F₂ can be fixed as 1 in this case.

In another case (e.g., case 3 in FIG. 10), the intended gap duration after applying the forward symbol extension for the configured sidelink transmission is 34 us, and the corresponding value of Δᵢ (i=3) is given by TABLE 2. In one consideration, F₃ can be fixed as 2^{μ} in this case. In another consideration, F₃ can be provided by higher layer parameter. In yet another consideration, F₃ can be fixed as 1 in this case.

In another case (e.g., case 4 in FIG. 10), the intended gap duration after applying the forward symbol extension for the configured sidelink transmission is 43 us, and the corresponding value of Δᵢ (i=4) is given by TABLE 2. In one consideration, F₄ can be fixed as 2^{μ} in this case. In another consideration, F₄ can be provided by higher layer parameter. In yet another consideration, F₄ can be fixed as 1 in this case.

In another case (e.g., case 5 in FIG. 10), the intended gap duration after applying the forward symbol extension for the configured sidelink transmission is 52 us, and the corresponding value of Δᵢ (i=5) is given by TABLE 2. In one consideration, F₅ can be fixed as 2^{μ} in this case. In another consideration, F₅ can be provided by higher layer parameter. In yet another consideration, F₅ can be fixed as 1 in this case.

In another case (e.g., case 6 in FIG. 10), the intended gap duration after applying the forward symbol extension for the configured sidelink transmission is 61 us, and the corresponding value of Δᵢ (i=6) is given by TABLE 2. In one consideration, F₆ can be fixed as 2^{μ} in this case. In another consideration, F₆ can be provided by higher layer parameter. In yet another consideration, F₆ can be fixed as 1 in this case.

In another case (e.g., case 7 in FIG. 10), the intended gap duration after applying the forward symbol extension for the configured sidelink transmission is a number of symbol(s), or the duration of the forward symbol extension for the configured sidelink transmission is 0, and the corresponding value of Δᵢ (i=7) is given by TABLE 2. In one consideration, F₇ can be fixed as 2^{μ} in this case. In another consideration, F₇ can be provided by higher layer parameter. In yet another consideration, F₇ can be fixed as 1 in this case.

In another example, the duration of the forward extension of a sidelink symbol can be supported for at least one of the following cases. In these cases, a timing difference ΔT_{TA} can contribute to the determination of Tₑₓₜ.

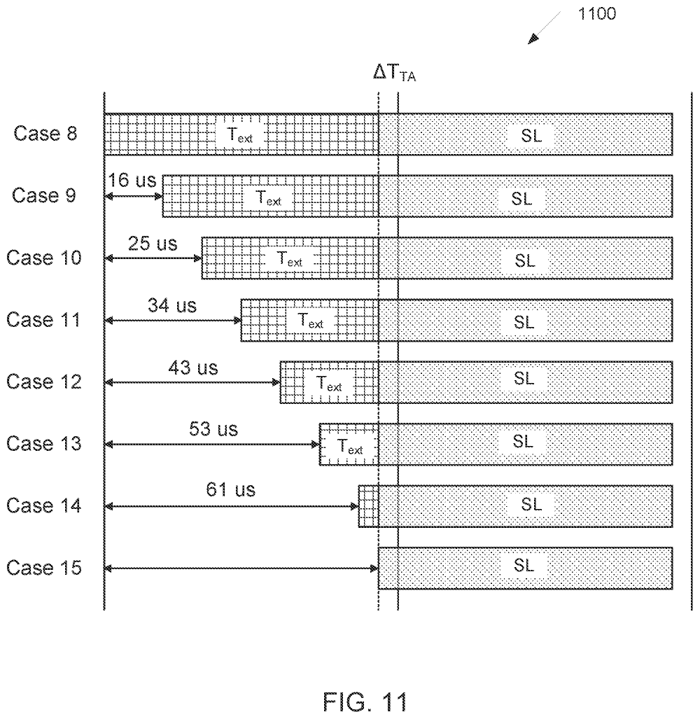

FIG. 11 illustrates another example of forward symbol extension for configured sidelink transmission 1100 according to various embodiments of the present disclosure. An embodiment of the forward symbol extension for configured sidelink transmission 1100 shown in FIG. 11 is for illustration only.

In another case (e.g., case 8 in FIG. 11), the intended gap duration after applying the forward symbol extension for the configured sidelink transmission is 0, and the corresponding value of Δᵢ (i=8) is given by TABLE 2. In one consideration, F₈ can be fixed as 2^{μ} in this case. In another consideration, F₈ can be determined as the integer such that Tₑₓₜ is between 0 and a symbol duration with respect to 15 kHz SCS. In yet another consideration, F₈ can be provided by higher layer parameter. In yet another consideration, F₈ can be fixed as 1 in this case.

In another case (e.g., case 9 in FIG. 11), the intended gap duration after applying the forward symbol extension for the configured sidelink transmission is 16 us, and the corresponding value of Δᵢ (i=9) is given by TABLE 2. In one consideration, F₉ can be fixed as 2^{μ} in this case. In another consideration, F₉ can be determined as the integer such that Tₑₓₜ is between 0 and a symbol duration with respect to 15 kHz SCS. In yet another consideration, F₉ can be provided by higher layer parameter. In yet another consideration, F₉ can be fixed as 1 in this case.

In another case (e.g., case 10 in FIG. 11), the intended gap duration after applying the forward symbol extension for the configured sidelink transmission is 25 us, and the corresponding value of Δᵢ (i=10) is given by TABLE 2. In one consideration, F₁₀ can be fixed as 2^{μ} in this case. In another consideration, F₁₀ can be determined as the integer such that Tₑₓₜ is between 0 and a symbol duration with respect to 15 kHz SCS. In yet another consideration, F₁₀ can be provided by higher layer parameter. In yet another consideration, F₁₀ can be fixed as 1 in this case.

In another case (e.g., case 11 in FIG. 11), the intended gap duration after applying the forward symbol extension for the configured sidelink transmission is 34 us, and the corresponding value of Δᵢ (i=11) is given by TABLE 2. In one consideration, F₁₁ can be fixed as 2^{μ} in this case. In another consideration, F₁₁ can be determined as the integer such that Tₑₓₜ is between 0 and a symbol duration with respect to 15 kHz SCS. In yet another consideration, F₁₁ can be provided by higher layer parameter. In yet another consideration, F₁₁ can be fixed as 1 in this case.

In another case (e.g., case 12 in FIG. 11), the intended gap duration after applying the forward symbol extension for the configured sidelink transmission is 43 us, and the corresponding value of Δᵢ (i=12) is given by TABLE 2. In one consideration, F₁₂ can be fixed as 2^{μ} in this case. In another consideration, F₁₂ can be determined as the integer such that Tₑₓₜ is between 0 and a symbol duration with respect to 15 kHz SCS. In yet another consideration, F₁₂ can be provided by higher layer parameter. In yet another consideration, F₁₂ can be fixed as 1 in this case.

In another case (e.g., case 13 in FIG. 11), the intended gap duration after applying the forward symbol extension for the configured sidelink transmission is 52 us, and the corresponding value of Δᵢ (i=13) is given by TABLE 2. In one consideration, F₁₃ can be fixed as 2^{μ} in this case. In another consideration, F₁₃ can be determined as the integer such that Tₑₓₜ is between 0 and a symbol duration with respect to 15 kHz SCS. In yet another consideration, F₁₃ can be provided by higher layer parameter. In yet another consideration, F₁₃ can be fixed as 1 in this case.

In another case (e.g., case 14 in FIG. 11), the intended gap duration after applying the forward symbol extension for the configured sidelink transmission is 61 us, and the corresponding value of Δᵢ (i=14) is given by TABLE 2. In one consideration, F₁₄ can be fixed as 2^{μ} in this case. In another consideration, F₁₄ can be determined as the integer such that Tₑₓₜ is between 0 and a symbol duration with respect to 15 kHz SCS. In yet another consideration, F₁₄ can be provided by higher layer parameter. In yet another consideration, F₁₄ can be fixed as 1 in this case.

In another case (e.g., case 15 in FIG. 11), the duration of the forward symbol extension for the configured sidelink transmission is 0, and the corresponding value of Δᵢ (i=15) is given by TABLE 2. In one consideration, F₁₅ can be fixed as 2^{μ} in this case. In another consideration, F₁₅ can be determined as the integer such that Tₑₓₜ is between 0 and a symbol duration with respect to 15 kHz SCS. In yet another consideration, F₁₅ can be provided by higher layer parameter. In yet another consideration, F₁₅ can be fixed as 1 in this case.

For ΔT_{TA} in the above examples, it can include at least one of the following components: 1) the sidelink transmission is using a DL timing as its reference timing, and ΔT_{TA} includes the sidelink timing difference T_{TA,SL}=N_{TA,offset}·T_{C}, e.g., ΔT_{TA}=T_{TA,SL}; 2) the sidelink transmission is using a UL timing as its reference timing, and ΔT_{TA} includes the timing difference between uplink and sidelink, e.g., ΔT_{TA}=T_{TA,SL}−T_{TA,} wherein T_{TA} is the timing advance of the uplink transmission; 3) the sidelink transmission is using another sidelink transmission as its reference timing, and ΔT_{TA} includes the propagation delay between the two SL transmissions Tₚᵣₒₚ; 4) the reference timing of the sidelink transmission can have an asynchronous delay comparing to a common source (e.g., absolute timing), and ΔT_{TA} can include such timing difference ΔT_{sync}. In one instance, at least one component for ΔT_{TA} can be configured by the gNB, and the UE applies such component when determining the value of ΔT_{TA}. In another instance, at least one component for ΔT_{TA} can be determined by the UE and applied by the UE when determining the value of ΔT_{TA}.

TABLE 2
Parameters of forward symbol extension for
configured sidelink transmission

| Tₑₓₜ index i | Fᵢ | Δᵢ |
|---|---|---|
| 0 | F₀ | 0 |
| 1 | F₁ | 16 · 10⁻⁶ |
| 2 | F₂ | 25 · 10⁻⁶ |
| 3 | F₃ | 34 · 10⁻⁶ |
| 4 | F₄ | 43 · 10⁻⁶ |
| 5 | F₅ | 52 · 10⁻⁶ |
| 6 | F₆ | 61 · 10⁻⁶ |
| 7 | F₇ | Σₖ₌₁^{F}^{₇} T_{symb, (l-k)mod 7·2}_{^{μ}}^{μ} |
| 8 | F₈ | ΔT_{TA} |
| 9 | F₉ | 16 · 10⁻⁶ + ΔT_{TA} |
| 10 | F₁₀ | 25 · 10⁻⁶ + ΔT_{TA} |
| 11 | F₁₁ | 34 · 10⁻⁶ + ΔT_{TA} |
| 12 | F₁₂ | 43 · 10⁻⁶ + ΔT_{TA} |
| 13 | F₁₃ | 52 · 10⁻⁶ + ΔT_{TA} |
| 14 | F₁₄ | 61 · 10⁻⁶ + ΔT_{TA} |
| 15 | F₁₅ | Σₖ₌₁^{F}^{₁₅} T_{symb, (l-k)mod 7·2}_{^{μ}}^{μ} + |
| | | ΔT_{TA} |

In one embodiment, an OFDM symbol for sidelink transmission can be backward extended for a duration of T̅ₑₓₜ.

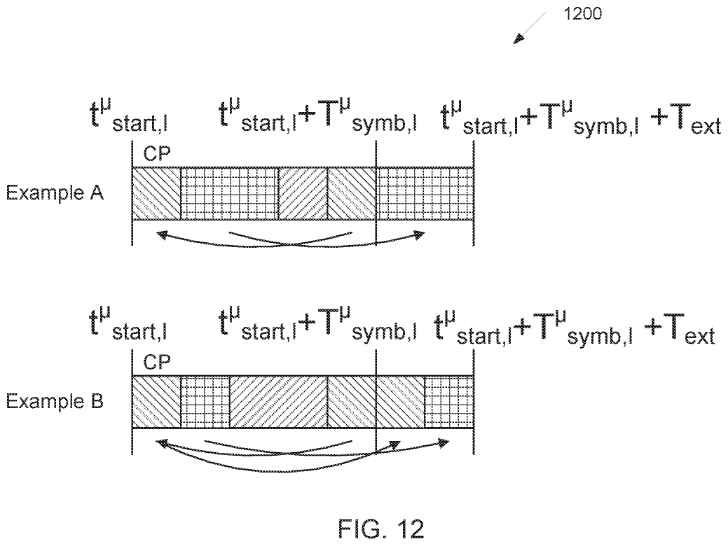

FIG. 12 illustrates an example of backward symbol extension 1200 according to various embodiments of the present disclosure. An embodiment of the backward symbol extension 1200 shown in FIG. 12 is for illustration only.

For one example, the time-continuous signal sₑₓₜ^{(p,μ)}(t) for the interval t_{start,l}^{μ}+T_{symb,l}^{μ}≤t<t_{start,l}^{μ}+T_{symb,l}^{μ}+T̅ₑₓₜ succeeding the sidelink OFDM symbol is given by sₑₓₜ^{(p,μ)}(t)=s̅ₗ^{(p,μ)}(t), or sₑₓₜ^{p,μ)}(t)=s̅ₗ^{(p,μ)}(t−T_{symb,l}^{μ}+N_{CP,l}^{μ}·T_{c}), and an illustration of this example for backward symbol extension is shown in Example A of FIG. 12, wherein the portions with the same pattern are repeated.

For another example, the time-continuous signal sₑₓₜ^{(p,μ)}(t) for the interval t_{start,l}^{μ}+T_{symb,l}^{μ}≤t<t_{start,l}^{μ}+T_{symb,l}^{μ}+T̅ₑₓₜ succeeding the sidelink OFDM symbol is given by sₑₓₜ^{(p,μ)}(t)=s̅ₗ^{(p,μ)}(t−N_{CP,l}^{μ}·T_{c}), or sₑₓₜ^{(p,μ)}(t)=s̅ₗ^{(p,μ)}(t−T_{symb,l}^{μ}), and an illustration of this example for backward symbol extension is shown in Example B of FIG. 12, wherein the portions with the same pattern are repeated.

In one example, for a configured sidelink transmission (e.g., configured PSSCH and/or PSFCH and/or S-SS/PSBCH block), the duration of the backward extension of a sidelink symbol (e.g., the last symbol of the sidelink transmission) can be given by T̅ₑₓₜ=Σₖ₌₁^{G}^{ᵢ}T_{symb,(l-k)mod 7·2}_{^{μ}}−Δᵢ^{μ}.

In another example, for a configured sidelink transmission (e.g., configured PSSCH and/or PSFCH and/or S-SS/PSBCH block), the duration of the backward extension of a sidelink symbol (e.g., the first symbol of the sidelink transmission) can be given by T̅ₑₓₜ=max(Σₖ₌₁^{G}^{ᵢ}T_{symb,(l+k)mod 7·2}_{^{μ}}μ−Δᵢ,0).

In yet another example, for a configured sidelink transmission (e.g., configured PSSCH and/or PSFCH and/or S-SS/PSBCH block), the duration of the backward extension of a sidelink symbol (e.g., the first symbol of the sidelink transmission) can be given by T̅ₑₓₜ=min(max(Σₖ₌₁^{G}^{ᵢ}T_{symb,(l+k)mod 7·2}_{^{μ}}μ−Δᵢ,0), Σₖ₌₁²^{^{μ}}T_{symb,(l+k)mod 7·2}_{^{μ}}μ).

In yet another example, for a configured sidelink transmission (e.g., configured PSSCH and/or PSFCH and/or S-SS/PSBCH block), the duration of the backward extension of a sidelink symbol (e.g., the first symbol of the sidelink transmission) can be given by T̅ₑₓₜ=min(max(Σₖ₌₁^{G}^{ᵢ}T_{symb,(l+k)mod 7·2}_{^{μ}}μ−Δᵢ,0), T_{symb,(l+1)mod 7·2}_{^{μ}}μ).

In one example, the duration of the backward extension of a sidelink symbol can be supported for at least one of the following cases, wherein in the examples, T_{TA,SL}=N_{TA,offset}·T_{C} is the timing difference for sidelink transmissions comparing to its reference timing, and T_{TA} is the timing advance for uplink transmission.

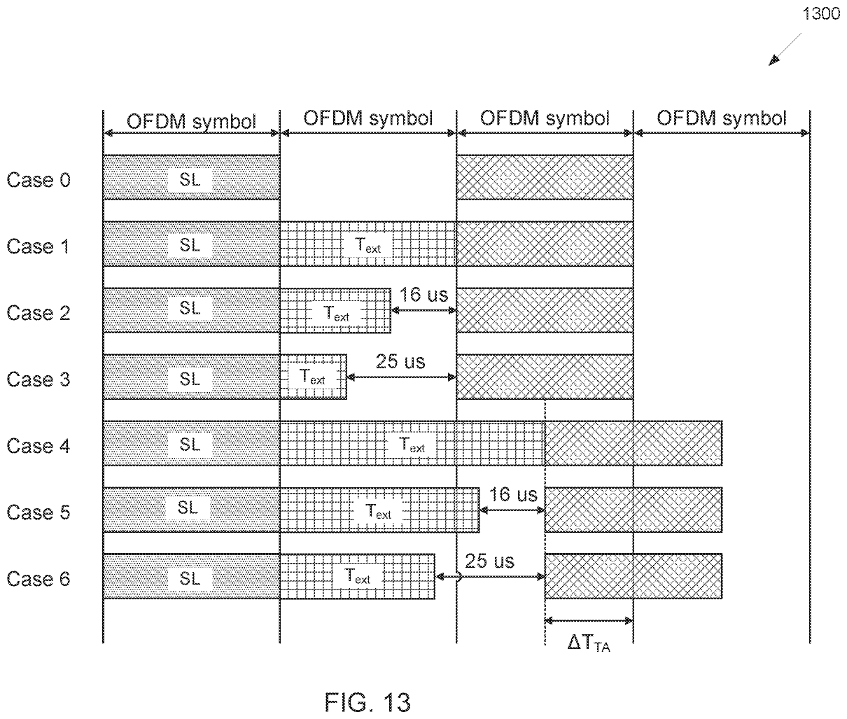

FIG. 13 illustrates an example of backward symbol extension for configured sidelink transmission 1300 according to various embodiments of the present disclosure. An embodiment of the backward symbol extension for configured sidelink transmission 1300 shown in FIG. 13 is for illustration only.

In another case (e.g., case 0 in FIG. 13), there is no backward symbol extension applied to the scheduled sidelink transmission, e.g., Tₑₓₜ=0.

In another case (e.g., case 1 in FIG. 13), the intended gap duration after applying the forward symbol extension for the configured sidelink transmission is 0, and the corresponding value of Δᵢ (i=1) is given by TABLE 3. In one consideration, G₁ can be fixed as 2^{μ} in this case. In another consideration, G₁ can be fixed as 1 in this case. In yet another consideration, G₁ can be provided by higher layer.

In one variant of this case, the backward symbol extension can be symbol repetition(s). For instance, the backward extension is using Example B of FIG. 12, and the last symbol of the scheduled sidelink transmission is repeated G₁ times and transmitted following the scheduled sidelink transmission.

In another case (e.g., case 2 in FIG. 13), the intended gap duration after applying the forward symbol extension for the configured sidelink transmission is 16 us, and the corresponding value of Δᵢ (i=2) is given by TABLE 3. In one consideration, G₂ can be fixed as 2^{μ} in this case. In another consideration, G₂ can be fixed as 1 in this case. In yet another consideration, G₂ can be provided by higher layer.

In another case (e.g., case 3 in FIG. 13), the intended gap duration after applying the forward symbol extension for the configured sidelink transmission is 25 us, and the corresponding value of Δᵢ (i=3) is given by TABLE 3. In one consideration, G₃ can be fixed as 2^{μ} in this case. In another consideration, G₃ can be fixed as 1 in this case. In yet another consideration, G₃ can be provided by higher layer.

In another case (e.g., case 4 in FIG. 13), the intended gap duration after applying the forward symbol extension for the configured sidelink transmission is 0, and the corresponding value of Δᵢ (i=4) is given by TABLE 3. In one consideration, G₄ can be fixed as 2^{μ} in this case. In another consideration, G₄ can be fixed as 1 in this case. In yet another consideration, G₄ can be provided by higher layer.

In another case (e.g., case 5 in FIG. 13), the intended gap duration after applying the forward symbol extension for the configured sidelink transmission is 16 us, and the corresponding value of Δᵢ (i=5) is given by TABLE 3. In one consideration, G₅ can be fixed as 2^{μ} in this case. In another consideration, G₅ can be fixed as 1 in this case. In yet another consideration, G₅ can be provided by higher layer.

In another case (e.g., case 6 in FIG. 13), the intended gap duration after applying the forward symbol extension for the configured sidelink transmission is 25 us, and the corresponding value of Δᵢ (i=6) is given by TABLE 3. In one consideration, G₆ can be fixed as 2^{μ} in this case. In another consideration, G₆ can be fixed as 1 in this case. In yet another consideration, G₆ can be provided by higher layer.

For ΔAT_{TA} in the above examples, it can include at least one of the following components: 1) the sidelink transmission is using a DL timing as its reference timing, and ΔT_{TA} includes the sidelink timing difference T_{TA,SL}=N_{TA,offset}·T_{C}, e.g., ΔT_{TA}=−T_{TA,SL}; 2) the sidelink transmission is using a UL timing as its reference timing, and ΔT_{TA} includes the timing difference between uplink and sidelink, e.g., ΔT_{TA}=T_{TA}−T_{TA,SL}, wherein T_{TA} is the timing advance of the uplink transmission; 3) the sidelink transmission is using another sidelink transmission as its reference timing, and ΔT_{TA} includes the propagation delay between the two SL transmissions Tₚᵣₒₚ; 4) the reference timing of the sidelink transmission can have an asynchronuous delay comparing to a common source (e.g., absolute timing), and ΔT_{TA} can include such timing difference ΔT_{sync}. In one instance, at least one component for ΔT_{TA} can be configured by the gNB, and the UE applies such component when determining the value of ΔT_{TA}. In another instance, at least one component for ΔT_{TA} can be determined by the UE and applied by the UE when determining the value of ΔT_{TA}.

TABLE 3
Parameters of backward symbol extension for
configured sidelink transmission

| T̅ₑₓₜ index i | Gᵢ | Δᵢ |
|---|---|---|
| 0 | — | — |
| 1 | G₁ | 0 |
| 2 | G₂ | 16 · 10⁻⁶ |
| 3 | G₃ | 25 · 10⁻⁶ |
| 4 | G₄ | ΔT_{TA} |
| 5 | G₅ | 16 · 10⁻⁶ + ΔT_{TA} |
| 6 | G₆ | 25 · 10⁻⁶ + ΔT_{TA} |

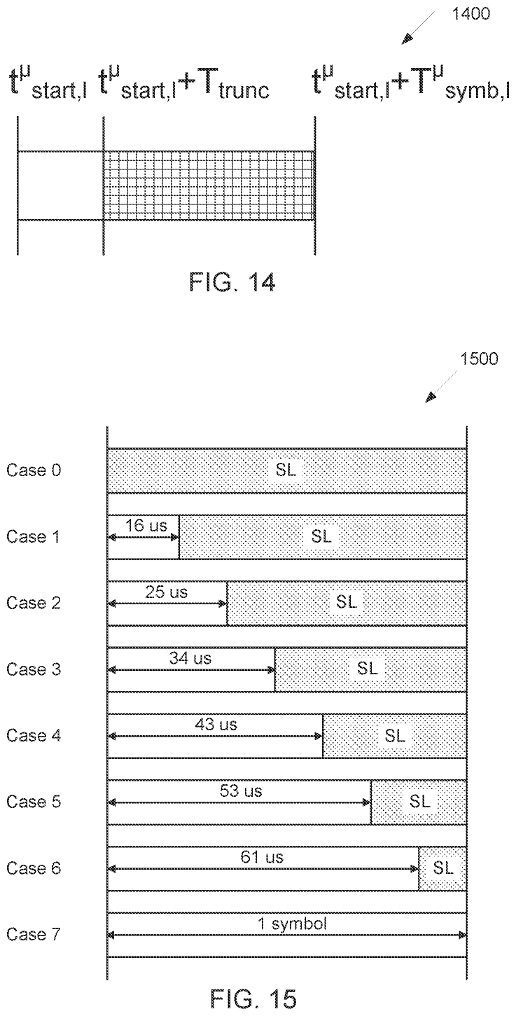

In one embodiment, an OFDM symbol for sidelink transmission can be truncated from the starting of the symbol for a duration of T_{trunc}. For instance, the symbol to be truncated can be the symbol for AGC purpose. For example, the time-continuous signal sₑₓₜ^{p,μ)}(t) for the interval t_{start,l}^{μ}≤t<t_{start,l}^{μ}+T_{trunc} for the first OFDM symbol is given by sₑₓₜ^{(p, μ)}(t)=0, and an illustration of this example for symbol truncation is shown in FIG. 14, wherein the portion without filling pattern is truncated.

FIG. 14 illustrates an example of symbol truncation 1400 according to various embodiments of the present disclosure. An embodiment of the symbol truncation 1400 shown in FIG. 14 is for illustration only.

In one example, for a configured sidelink transmission (e.g., configured PSSCH and/or PSFCH and/or S-SS/PSBCH block), the duration of the truncation of a sidelink symbol (e.g., the first symbol of the sidelink transmission) can be given by T_{trunc}=Δᵢ−Σₖ₋₁^{H}^{ᵢ}T_{symb,(l-k+1)mod 7·2}_{^{μ}}μ.

In another example, for a configured sidelink transmission (e.g., configured PSSCH and/or PSFCH and/or S-SS/PSBCH block), the duration of the truncation of a sidelink symbol (e.g., the first symbol of the sidelink transmission) can be given by T_{trunc}=min(max(Δᵢ−Σₖ₋₁^{H}^{ᵢ}T_{symb,(l-k+1)mod 7·2}_{^{μ}},μ0), T_{symb,l}^{μ}).

In one example, the duration of the symbol truncation of a sidelink symbol can be supported for at least one of the following cases.

FIG. 15 illustrates an example of symbol truncation for configured sidelink transmission 1500 according to various embodiments of the present disclosure. An embodiment of the symbol truncation for configured sidelink transmission 1500 shown in FIG. 15 is for illustration only.

In a first case (e.g., case 0 in FIG. 15), the intended gap duration after applying the symbol truncation for the configured sidelink transmission is 0, and the corresponding value of Δᵢ (i=0) is given by TABLE 4. In one consideration, H₀ can be fixed as 0 in this case. In another consideration, H₀ can be provided by higher layer parameter.

In another case (e.g., case 1 in FIG. 15), the intended gap duration after applying the symbol truncation for the configured sidelink transmission is 16 us, and the corresponding value of Δᵢ (i=1) is given by TABLE 4. In one consideration, H₁ can be fixed as 0 in this case. In another consideration, H₁ can be provided by higher layer parameter.

In another case (e.g., case 2 in FIG. 15), the intended gap duration after applying the symbol truncation for the configured sidelink transmission is 25 us, and the corresponding value of Δᵢ (i=2) is given by TABLE 4. In one consideration, H₂ can be fixed as 0 in this case. In another consideration, H₂ can be provided by higher layer parameter.

In another case (e.g., case 3 in FIG. 15), the intended gap duration after applying the symbol truncation for the configured sidelink transmission is 34 us, and the corresponding value of Δᵢ (i=3) is given by TABLE 4. In one consideration, H₃ can be fixed as 0 in this case. In another consideration, H₃ can be provided by higher layer parameter.

In another case (e.g., case 4 in FIG. 15), the intended gap duration after applying the symbol truncation for the configured sidelink transmission is 43 us, and the corresponding value of Δᵢ (i=4) is given by TABLE 4. In one consideration, H₄ can be fixed as 0 in this case. In another consideration, H₄ can be provided by higher layer parameter.

In another case (e.g., case 5 in FIG. 15), the intended gap duration after applying the symbol truncation for the configured sidelink transmission is 52 us, and the corresponding value of Δᵢ (i=5) is given by TABLE 4. In one consideration, H₅ can be fixed as 0 in this case. In another consideration, H₅ can be provided by higher layer parameter.

In another case (e.g., case 6 in FIG. 15), the intended gap duration after applying the symbol truncation for the configured sidelink transmission is 61 us, and the corresponding value of Δᵢ (i=6) is given by TABLE 4. In one consideration, H₆ can be fixed as 0 in this case. In another consideration, H₆ can be provided by higher layer parameter.

In another case (e.g., case 7 in FIG. 15), the intended gap duration after applying the symbol truncation for the configured sidelink transmission is a number of symbols, and the corresponding value of Δᵢ (i=7) is given by TABLE 4. In one consideration, H₇ can be fixed as 0 in this case. In another consideration, H₇ can be provided by higher layer parameter.

In another example, the duration of the symbol truncation of a sidelink symbol can be supported for at least one of the following cases.

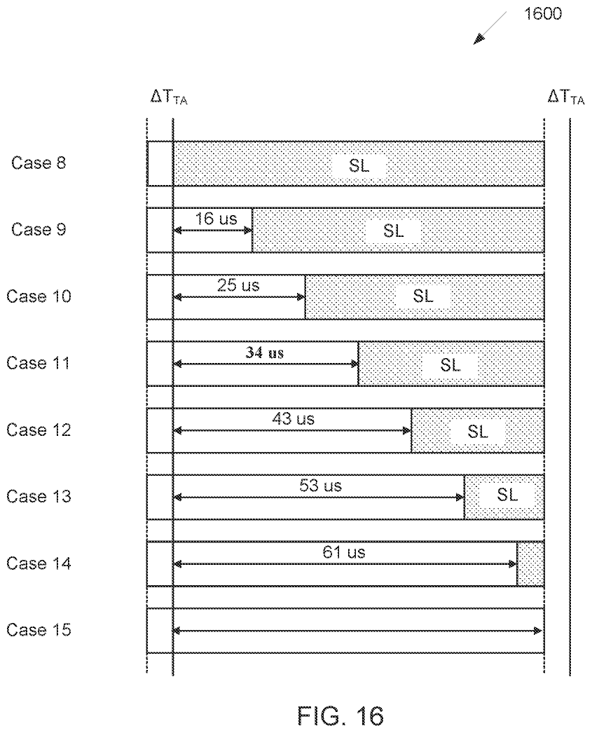

FIG. 16 illustrates an example of symbol truncation for configured sidelink transmission 1600 according to various embodiments of the present disclosure. An embodiment of the symbol truncation for configured sidelink transmission 1600 shown in FIG. 16 is for illustration only.

In another case (e.g., case 8 in FIG. 16), the intended gap duration after applying the symbol truncation for the configured sidelink transmission is 0, and the corresponding value of Δᵢ (i=8) is given by TABLE 4. In one consideration, H₈ can be fixed as 0 in this case. In another consideration, H₈ can be provided by higher layer parameter. In yet another consideration, H₈ can be determined as the integer such that T_{trunc} is between 0 and a symbol duration.

In another case (e.g., case 9 in FIG. 16), the intended gap duration after applying the symbol truncation for the configured sidelink transmission is 16 us, and the corresponding value of Δᵢ (i=9) is given by TABLE 4. In one consideration, H₉ can be fixed as 0 in this case. In another consideration, H₉ can be provided by higher layer parameter. In yet another consideration, H₉ can be determined as the integer such that T_{trunc} is between 0 and a symbol duration.

In another case (e.g., case 10 in FIG. 16), the intended gap duration after applying the symbol truncation for the configured sidelink transmission is 25 us, and the corresponding value of Δᵢ (i=10) is given by TABLE 4. In one consideration, H₁₀ can be fixed as 0 in this case. In another consideration, H₁₀ can be provided by higher layer parameter. In yet another consideration, H₁₀ can be determined as the integer such that T_{trunc} is between 0 and a symbol duration.

In another case (e.g., case 11 in FIG. 16), the intended gap duration after applying the symbol truncation for the configured sidelink transmission is 34 us, and the corresponding value of Δᵢ (i=11) is given by TABLE 4. In one consideration, H₁₁ can be fixed as 0 in this case. In another consideration, H₁₁ can be provided by higher layer parameter. In yet another consideration, H₁₁ can be determined as the integer such that T_{trunc} is between 0 and a symbol duration.

In another case (e.g., case 12 in FIG. 16), the intended gap duration after applying the symbol truncation for the configured sidelink transmission is 43 us, and the corresponding value of Δᵢ (i=12) is given by TABLE 4. In one consideration, H₁₂ can be fixed as 0 in this case. In another consideration, H₁₂ can be provided by higher layer parameter. In yet another consideration, H₁₂ can be determined as the integer such that T_{trunc} is between 0 and a symbol duration.

In a fourteenth case (e.g., case 13 in FIG. 16), the intended gap duration after applying the symbol truncation for the configured sidelink transmission is 52 us, and the corresponding value of Δᵢ (i=13) is given by TABLE 4. In one consideration, H₁₃ can be fixed as 0 in this case. In another consideration, H₁₃ can be provided by higher layer parameter. In yet another consideration, H₁₃ can be determined as the integer such that T_{trunc} is between 0 and a symbol duration.

In another case (e.g., case 14 in FIG. 16), the intended gap duration after applying the symbol truncation for the configured sidelink transmission is 61 us, and the corresponding value of Δᵢ (i=14) is given by TABLE 4. In one consideration, H₁₄ can be fixed as 0 in this case. In another consideration, H₁₄ can be provided by higher layer parameter. In yet another consideration, H₁₄ can be determined as the integer such that T_{trunc} is between 0 and a symbol duration.

In another case (e.g., case 15 in FIG. 16), the intended gap duration after applying the symbol truncation for the configured sidelink transmission is a number of symbols, and the corresponding value of Δᵢ (i=15) is given by TABLE 4. In one consideration, H₁₅ can be fixed as 0 in this case. In another consideration, H₁₅ can be provided by higher layer parameter. In yet another consideration, H₁₅ can be determined as the integer such that T_{trunc} is between 0 and a symbol duration.

For ΔT_{TA} in the above examples, it can include at least one of the following components: 1) the sidelink transmission is using a DL timing as its reference timing, and ΔT_{TA} includes the sidelink timing difference T_{TA,SL}=N_{TA,offset}·T_{C}, e.g., ΔT_{TA}=−T_{TA,SL}; 2) the sidelink transmission is using a UL timing as its reference timing, and ΔT_{TA} includes the timing difference between uplink and sidelink, e.g., ΔT_{TA}=T_{TA}−T_{TA,SL}, wherein T_{TA} is the timing advance of the uplink transmission; 3) the sidelink transmission is using another sidelink transmission as its reference timing, and ΔT_{TA} includes the propagation delay between the two SL transmissions Tₚᵣₒₚ; 4) the reference timing of the sidelink transmission can have an asynchronuous delay comparing to a common source (e.g., absolute timing), and ΔT_{TA} can include such timing difference ΔT_{sync}. In one instance, at least one component for ΔT_{TA} can be configured by the gNB, and the UE applies such component when determining the value of ΔT_{TA}. In another instance, at least one component for ΔT_{TA} can be determined by the UE and applied by the UE when determining the value of ΔT_{TA}.

TABLE 4
Parameters of symbol truncation for configured
sidelink transmission

| T_{trunc} index 1 | Hᵢ | Δᵢ |
|---|---|---|
| 0 | H₀ | 0 |
| 1 | H₁ | 16 · 10⁻⁶ |
| 2 | H₂ | 25 · 10⁻⁶ |
| 3 | H₃ | 34 · 10⁻⁶ |
| 4 | H₄ | 43 · 10⁻⁶ |
| 5 | H₅ | 52 · 10⁻⁶ |
| 6 | H₆ | 61 · 10⁻⁶ |
| 7 | H₇ | T_{symb, l}^{μ} |
| 8 | H₈ | ΔT_{TA} |
| 9 | H₉ | 16 · 10⁻⁶ + ΔT_{TA} |
| 10 | H₁₀ | 25 · 10⁻⁶ + ΔT_{TA} |
| 11 | H₁₁ | 34 · 10⁻⁶ + ΔT_{TA} |
| 12 | H₁₂ | 43 · 10⁻⁶ + ΔT_{TA} |
| 13 | H₁₃ | 52 · 10⁻⁶ + ΔT_{TA} |
| 14 | H₁₄ | 61 · 10⁻⁶ + ΔT_{TA} |
| 15 | H₁₅ | T_{symb, l}^{μ} + ΔT_{TA} |

In one embodiment, a UE can be indicated (explicitly or implicitly) with at least one of the cases for the sidelink symbol adjustment according to the mentioned embodiments/examples in the present disclosure.

In one approach, at least one of the cases for the sidelink symbol adjustment according to the mentioned embodiments/examples in the present disclosure can be supported for sidelink transmission, and the case(s) supported is fixed in the specification.

In one example, the support of fixed symbol adjustment is only for a sidelink with operation with shared spectrum channel access.

In one example, the support of fixed symbol adjustment can be for PSFCH.

In another example, the supported fixed symbol adjustment can be for S-SS/PSBCH block.

In one example, Case 0 of forward symbol extension can be supported for a configured sidelink transmission and fixed in the specification. For one sub-example, it is supported when the previous transmission is also a sidelink transmission from the same UE.

In another example, Case 1 of backward symbol extension can be supported for a configured sidelink transmission and fixed in the specification. For one sub-example, it is supported when the following transmission is also a sidelink transmission from the same UE.

In another approach, at least one of the cases for the sidelink symbol adjustment according to the mentioned embodiments/examples in the present disclosure can be supported for sidelink transmission, and the case(s) supported are indicated by higher layer parameters.

In one example, the support of symbol adjustment is only for a sidelink with operation with shared spectrum channel access.

In one example, a UE can be provided with at least one case of the forward symbol extension for sidelink transmissions by a RRC parameter.

In another example, a UE can be provided with one case of the backward symbol extension for sidelink transmissions by a RRC parameter.

In yet another example, a UE can be provided with at least one case of the forward symbol extension and/or symbol truncation for sidelink transmissions by a RRC parameter.

In one example, then a UE is performing a sidelink transmission with configured grants in a set of contiguous OFDM symbols on all resource blocks of an RB set, for the first such sidelink transmission, the UE determines a duration of sidelink symbol adjustment according to a case of the mentioned embodiments/examples in the present disclosure, wherein the index of the case can be chosen by the UE randomly from a set of values provided by higher layer parameters. In one sub-example, if the first such sidelink transmission is within a channel occupancy (e.g., initialized by a gNB or UE), the set of values can be determined as a first higher layer parameter associated with all resource blocks of an RB set. In another sub-example, if the first such sidelink transmission is not within a channel occupancy (e.g., initialized by a gNB or UE), the set of values can be determined as a second higher layer parameter associated with all resource blocks of an RB set.

In another example, then a UE is performing a sidelink transmission with configured grants in a set of contiguous OFDM symbols on fewer than all resource blocks of an RB set, for the first such sidelink transmission, the UE determines a duration of sidelink symbol adjustment according to a case of the mentioned embodiments/examples in the present disclosure, wherein the index of the case can be provided by higher layer parameters. In one sub-example, if the first such sidelink transmission is within a channel occupancy (e.g., initialized by a gNB or UE), the set of values can be determined as a first higher layer parameter associated with fewer than all resource blocks of an RB set. In another sub-example, if the first such sidelink transmission is not within a channel occupancy (e.g., initialized by a gNB or UE), the set of values can be determined as a second higher layer parameter associated with fewer than all resource blocks of an RB set.

In one embodiment, a sidelink transmission and a uplink transmission can be multiplexed and use the same symbol as the starting symbol of the transmission. For example, the sidelink transmission and the uplink transmission can be FDMed (e.g., mapped to different RBs) or IFDMed (e.g., mapped to different interlaces of RBs). For this embodiment, CP extension can be indicated and applied to the starting symbol for uplink transmission, and symbol adjustment (e.g., forward symbol extension and/or symbol truncation) can be indicated and applied to the starting symbol for sidelink transmission.

In one example, a UE is not expected to be dynamically scheduled (e.g., by a DCI and/or a SCI) with a sidelink transmission at a symbol that overlaps in time with a transmission occasion for a sidelink transmission with configured grant.

In another example, a UE is not expected to be dynamically scheduled (e.g., by a DCI and/or a SCI) with a sidelink transmission at a symbol that overlaps in time with a transmission occasion for a uplink transmission with configured grant.

In yet another example, a UE is not expected to be dynamically scheduled (e.g., by a DCI) with an uplink transmission at a symbol that overlaps in time with a transmission occasion for a sidelink transmission with configured grant.

In one example, a UE performs channel access procedures for the sidelink transmission and the uplink transmission separately (e.g., based on UE's capability), and the UE could be indicated with a first symbol duration adjustment (e.g., CP extension) for the sidelink transmission and a second CP extension for the uplink transmission.

In one sub-example, the UE expects the transmission starting time (e.g., with respect to DL timing) for the sidelink transmission and uplink transmission are aligned after applying the CP extensions respectively.

In another sub-example, if the starting time (e.g., with respect to DL timing) for the sidelink transmission and uplink transmission after applying the CP extensions respectively are not aligned, the UE can further extend the CP for the transmission with later starting time and align the starting time of the sidelink and uplink transmissions. For this sub-example, the UE may adjust the channel access procedure for the transmission with the later starting time to the same channel access procedure for the transmission with the earlier starting time.

In one example, a UE performs channel access procedure for the sidelink transmission and the uplink transmission jointly (e.g., based on UE's capability), and the UE could be indicated with a first symbol duration adjustment (e.g., CP extension) for the sidelink transmission and a second CP extension for the uplink transmission.

In one sub-example, the UE expects the transmission starting time (e.g., with respect to DL timing) for the sidelink transmission and uplink transmission are aligned after applying the CP extensions respectively.

In another sub-example, if the starting time (e.g., with respect to DL timing) for the sidelink transmission and uplink transmission after applying the CP extensions respectively are not aligned, the UE performs the joint channel access procedure before the earlier starting time of the transmission and start transmitting both slidelink and uplink transmissions if the channel access procedure completes.

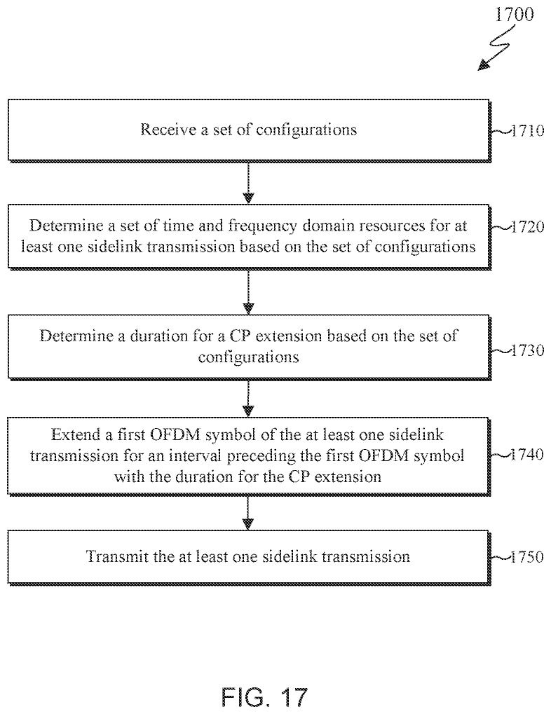

FIG. 17 illustrates an example method 1700 for ODFM symbol adjustment for SL transmissions according to embodiments of the present disclosure. The steps of the method 1700 of FIG. 17 can be performed by any of the UEs 111-116 of FIG. 1, such as the UE 116 of FIG. 3. The method 1700 is for illustration only and other embodiments can be used without departing from the scope of the present disclosure.

The method 1700 begins with the UE receiving a set of configurations (step 1710). For example, in step 1710, the set of configurations may be provided by higher layer parameters or pre-configured. The UE then determines a set of time and frequency domain resources for at least one SL transmission based on the set of configurations (step 1720). For example, in step 1720, the at least one SL transmission may be a PSSCH, a physical PSFCH, or a S-SS/PSBCH block. The UE determines a duration for a CP extension based on the set of configurations (step 1730).

The UE then extends a first OFDM symbol of the at least one SL transmission for an interval preceding the first OFDM symbol with the duration for the CP extension (step 1740). For example, in step 1740, the interval preceding the first OFDM symbol may be given by t_{start,l}^{μ}−Tₑₓₜ≤t<t_{start,l}^{μ}, t_{start,l}^{μ} is a start instance of the first OFDM symbol, and Tₑₓₜ=min(max(Σₖ₋₁^{F}^{ᵢ}T_{symb,(l-k+1)mod 7·2}_{^{μ}}μ−Δᵢ,0), T_{symb,(l-1)mod 7·2}_{^{μ}}^{μ}), where Δᵢ is determined, based on the set of configurations, as one case from: case 0: Δᵢ=0; case 1: Δᵢ=16·10⁻⁶; case 2: Δᵢ=25·10^{-6;} case 3: Δᵢ=34·10^{-6;} case 4: Δᵢ=43 10^{-6;} case 5: Δᵢ=52 10^{-6;} case 6: Δᵢ=61·10^{-6;} or case 7: Δᵢ=Σₖ₌₁^{F}^{ᵢ}T_{symb,(l-k)mod 7·2}_{^{μ}}μ and Fᵢ is determined based on the set of configurations or is determined as 2^{μ}, if not provided by the set of configurations

In various embodiments, the UE may also determine a duration for a backward symbol extension based on the set of configurations and extend a last OFDM symbol of the at least one SL transmission for an interval succeeding the last OFDM symbol with the duration for the backward symbol extension. In this example, the interval succeeding the last OFDM symbol may be given by t̅_{start,l}^{μ}+T_{symb,l}^{μ}≤t<t̅_{start,l}^{μ}+T_{symb,l}^{μ}+T̅ₑₓₜ, t̅_{start,l}^{μ} is determined, based on the set of configurations, as one case from: case 0: Δᵢ=0; case 1: Δᵢ=16·10^{-6;} case 2: Δᵢ=25·10^{-6;} or case 3: Δᵢ=Σₖ₌₁^{G}^{ᵢ}T_{symb,(l-k)mod 7·2}_{^{μ}}μ and Gᵢ is determined based on the set of configurations or is determined as 2^{μ}, if not provided by the set of configurations

Thereafter, the UE transmits the at least one SL transmission (step 1750). For example, in step 1750, the UE transmits the at least one SL transmission using the set of time and frequency domain resources and with the extension(s).

The above flowcharts and signaling flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of configurations; and
a processor operably coupled to the transceiver, the processor configured to:
determine a set of time and frequency domain resources for at least one sidelink transmission based on the set of configurations;
determine a duration for a cyclic prefix (CP) extension based on the set of configurations; and
extend a first orthogonal frequency-division multiplexing (OFDM) symbol of the at least one sidelink transmission for an interval preceding the first OFDM symbol with the duration for the CP extension,
wherein the transceiver is further configured to transmit the at least one sidelink transmission.

2. The UE of claim 1, wherein:
the interval preceding the first OFDM symbol is given by t_{start,l}^{μ}−Tₑₓₜ≤t<t_{start,l}^{μ},
t_{start,l}^{μ} is a start instance of the first OFDM symbol, and
Tₑₓₜ=min(max(Σₖ₌₁^{F}^{ᵢ}T_{symb,(l-k)mod 7·2}_{^{μ}}^{μ}−Δᵢ,0),T_{symb,l-1)mod 7·2}_{^{μ}}^{μ}).

3. The UE of claim 2, wherein Δᵢ is determined, based on the set of configurations, as one case from:
case 0: Δᵢ=0;
case 1: Δᵢ=16·10⁻⁶;
case 2: Δᵢ=25·10⁻⁶;
case 3: Δᵢ=34·10⁻⁶;
case 4: Δᵢ=43·10⁻⁶;
case 5: Δᵢ=52·10⁻⁶;
case 6: Δᵢ=61·10⁻⁶; or
case7: Δᵢ=(Σₖ₌₁^{F}^{ᵢ}T_{symb,(l-k)mod 7·2}_{^{μ}}^{μ}.

4. The UE of claim 2, wherein is determined based on the set of configurations, or is determined as 2^{μ}, if not provided by the set of configurations.

5. The UE of claim 1, wherein the at least one sidelink transmission is a physical sidelink shared channel (PSSCH), a physical sidelink feedback channel (PSFCH), or a sidelink synchronization signals and physical sidelink broadcast channel (S-SS/PSBCH) block.

6. The UE of claim 1, wherein the set of configurations is provided by higher layer parameters or pre-configured.

7. The UE of claim 1, wherein the processor is further configured to:
determine a duration for a backward symbol extension based on the set of configurations; and
extend a last OFDM symbol of the at least one sidelink transmission for an interval succeeding the last OFDM symbol with the duration for the backward symbol extension.

8. The UE of claim 7, wherein:
the interval succeeding the last OFDM symbol is given by t̅_{start,l}^{μ}+T_{symb,l}^{μ}≤t<t_{start,l}^{μ}+T_{symb,l}^{μ}+T̅ₑₓₜ,
t̅_{start,l}^{μ} is a start instance of the first OFDM symbol, and
T̅ₑₓₜ=min(max(Σₖ₌₁^{G}^{ᵢ}T_{symb,(l-k)mod 7·2}_{^{μ}}^{μ}−Δᵢ,0),T_{symb,(l-1)mod 7·2}_{^{μ}}^{μ}).

9. The UE of claim 8, wherein Δᵢ is determined, based on the set of configurations, as one case from:
case 0: Δᵢ=0;
case 1: Δᵢ1=6·10⁻⁶;
case 2: Δᵢ=25·0⁻⁶; or
case3: Δᵢ=Σₖ₌₁^{G}^{ᵢ}T_{symb,(l-k)mod 7·2}_{^{μ}}μ.

10. The UE of claim 8, wherein Gᵢ:
is determined based on the set of configurations, or
is determined as 2^{μ}, if not provided by the set of configurations.

11. A method of user equipment (UE) in a wireless communication system, the method comprising:
receiving a set of configurations;
determining a set of time and frequency domain resources for at least one sidelink transmission based on the set of configurations;
determining a duration for a cyclic prefix (CP) extension based on the set of configurations;
extending a first orthogonal frequency-division multiplexing (OFDM) symbol of the at least one sidelink transmission for an interval preceding the first OFDM symbol with the duration for the CP extension; and
transmitting the at least one sidelink transmission.

12. The method of claim 11, wherein:
the interval succeeding the last OFDM symbol is given by t_{start,l}^{μ}−Tₑₓₜ≤t<t_{start,l}^{μ},
t_{start,l}^{μ} is a start instance of the first OFDM symbol, and
Tₑₓₜ=min(max(Σₖ₌₁^{F}^{ᵢ}T_{symb,(l-k)mod 7·2}_{^{μ}}^{μ}−Δᵢ,0),T_{symb,(l-1)mod 7·2}_{^{μ}}^{μ}).

13. The method of claim 12, wherein i is determined, based on the set of configurations, as one case from:
case 0: Δᵢ=0;
case 1: Δᵢ=16·10⁻⁶;
case 2: Δᵢ=25·10⁻⁶;
case 3: Δᵢ=34√10⁻⁶;
case 4: Δᵢ=43·10⁻⁶;
case 5: Δᵢ=52·10⁻⁶;
case 6: Δᵢ=61·10⁻⁶; or
case7: Δᵢ=Σₖ₌₁^{F}^{ᵢ}T_{symb,(l-k)mod 7·2}_{^{μ}}^{μ}.

14. The method of claim 12, wherein Fᵢ:
is determined based on the set of configurations, or
is determined as 2^{μ}, if not provided by the set of configurations.

15. The method of claim 11, wherein the at least one sidelink transmission is a physical sidelink shared channel (PSSCH), a physical sidelink feedback channel (PSFCH), or a sidelink synchronization signals and physical sidelink broadcast channel (S-SS/PSBCH) block.

16. The method of claim 11, wherein the set of configurations is provided by higher layer parameters or pre-configured.

17. The method of claim 11 further comprising:
determining a duration for a backward symbol extension based on the set of configurations; and
extending a last OFDM symbol of the at least one sidelink transmission for an interval succeeding the last OFDM symbol with the duration for the backward symbol extension.

18. The method of claim 17, wherein: t̅_{start,l}^{μ}+T_{symb,l}^{μ}≤t<t_{start,l}^{μ}+T_{symb,l}^{μ}+T̅ₑₓₜ,
t̅_{start,l}^{μ} is a start instance of the first OFDM symbol, and
T̅ₑₓₜ=min(max(Σₖ₌₁^{G}^{ᵢ}T_{symb,(l-k)mod 7·2}_{^{μ}}^{μ}−Δᵢ,0),T_{symb,(l-1)mod 7·2}_{^{μ}}^{μ}).

19. The method of claim 18, wherein Δᵢ is determined, based on the set of configurations, as one case from:
case 0: Δᵢ=0;
case 1: Δᵢ=16·10⁻⁶;
case 2: Δᵢ=25·10⁻⁶; or
case3: Δᵢ=(Σₖ₌₁^{G}^{ᵢ}T_{symb,(l-k)mod 7·2}_{^{μ}}^{μ}.

20. The method of claim 18, wherein Gᵢ is:
determined based on the set of configurations, or
is determined as 2^{μ}, if not provided by the set of configurations.
